(19) United States
(12) Patent Application Publication
(10) Pub. No.: US 2008/0193720 A1
(43) Pub. Date: Aug. 14, 2008

(54) Structure of Safeguard Film for Cellular Phone

(76) Inventor: Dae-Young Kim, Seoul (KR)

Correspondence Address: ALFRED A. STADNICKI, 1300 NORTH SEVENTEENTH STREET, SUITE 1800, ARLINGTON, VA, 22209, US

(21) Appl. No.: 11/913,593

(22) PCT Filed: Oct. 19, 2006
(86) PCT No.: PCT/KR2006/004247

§ 371 Date: Nov. 5, 2007

(30) Foreign Application Priority Data
Oct. 21, 2005 (KR) 20-2005-0030024

(51) Int. Cl. B32B 3/00

(52) U.S. Cl. 428/161

(57) ABSTRACT

The present invention relates to a structure of safeguard film for cellular phone, comprising: at least one of adhesion facilitating means 20, 30, 40, 50, and 60 comprising: inception parts 21, 31, 41, 51, and 61 where a side wall 11 of a safeguard film 10 begins to depress with a certain length toward inside of the safeguard film; inside extension parts 22, 32, 42, 52, and 62 extending from the inception parts 21, 31, 41, 51, and 61 toward the inside of the safeguard film 10 in a manner that width of the inside is narrower than that of the outside; and tips 23, 33, 43, 53, and 63 formed with a curvature on end of the inside extension parts 22, 32, 42, 52, and 62. The present invention offers an advantage that the safeguard film can be attached on the adhering portion of the cellular phone having curved surface as well as the advantage that the present invention prevent the safeguard film from deviating easily from the cellular phone, along with the current demand for a structure of thin safeguard film specified to various models of cellular phone. Also, the present invention has another advantage that it can be utilized in general purpose without being subjected to a specific model of cellular phone by enhancing adhesion force corresponding to various adhering portions of the cellular phone.

### TECHNICAL FIELD

The present invention relates to a structure of safeguard film for cellular phone, and more particularly, to a structure of safeguard film for cellular phone formed with an adhesion facilitating means on peripheral edges of a film to prevent the membrane-like film covering a display part, key pad of a cellular phone, etc. from getting loose on or being detached from a surface of the cellular phone for a long period of time.

### BACKGROUND ART

Today, a wireless communication terminal device, which is commonly referred to as a cellular phone, or a mobile phone and considered as one of necessities for contemporary people, may be distinguished into three types of folder, slider, and non-folder, based on a method of using an interface provided with the key pad. Regardless of the type, a top surface of a cellular phone is subject to scratches that may be made during a normal course of life, even though it is made of metal, plastic, or material coated with plastic. However, such scratches have a tendency to deteriorate texture of the cellular phone which is relatively expensive compared to other electronic devices. Particularly, there exists a disadvantage that finger prints or oiliness of a hand remaining on a display part comprised of a LCD panel tend to obscure a screen, thereby a user has to wipe the screen with a tissue frequently.

To prevent such a disadvantage, domestic product or Korean utility model already discloses a case made of leather, or plastic to protect the cellular phone. However, the case still has a disadvantage of having too much volume and thickness, making it uncomfortable for a user to press the key pad when the case is covering the cellular phone. Besides, its unaesthetic appearance makes the case less favorable to the users.

Meanwhile, a membrane-type safeguard film for cellular phone that emerged in such market environment has an advantage that it protects the surface of the cellular phone sufficiently by covering the display part of the cellular phone, while not hampering both of basic function and aesthetic of the cellular phone at the same time.

Because of such an advantage, the membrane-type safeguard film is used widely and the applicant of the present invention filed a utility model on the safeguard film for cellular phone using such film.

### DISCLOSURE OF INVENTION

### Technical Problem

Although it has an advantage of taking membrane shape, it is still disadvantageous that the safeguard film is detached easily from the top surface of the cellular phone after using for a certain period of time because the safeguard film is attached on the top surface of the cellular phone using the force of static electricity of the membrane film, not employing any kind of adhesive at all. However, applying the adhesive on the safeguard film to prevent such problem will not make it look good from the aesthetic perspective. Besides, it will taint the surface of the cellular phone when the safeguard film needs to be removed off from the cellular phone.

In addition, the surface of the cellular phone is commonly formed in convex shape or in curvature, not in flat plate shape. As a result, when the safeguard film is attached on the cellular phone having such structure, a portion of the safeguard film, particularly, an edge part of the safeguard film gets loose and will not cover the cellular phone tightly, leaving an unnecessary gap. Accordingly, such a gap remains as another disadvantage, causing the safeguard film to detach from and flap off the cellular phone.

### Technical Solution

The present invention is devised to overcome problems described above, an objective of which is achieved by providing a safeguard film having an adhesion facilitating means being capable of sustaining a proper adhesive force on a surface of a cellular phone, regardless of the flat or curved structure of the cellular phone, in purpose of protecting a specific portion of the cellular phone for a long period of time.

Another objective of the present invention is achieved by providing diversity in a method of sustaining the adhesive force by adding functional diversity to the shape of the adhesion facilitating means.

Another objective of the present invention is achieved by providing a safeguard film with a plurality of the adhesion facilitating means having various shapes, so that the safeguard film can be compatible easily with various released models of cellular phones regardless of property of the cellular phone as well as reinforcing the adhesive force.

### Advantageous Effects

As described above, the present invention offers an advantage that the safeguard film can be attached on the adhering portion of the cellular phone having curved surface as well as the advantage that the present invention prevent the safeguard film from deviating easily from the cellular phone, along with the current demand for a structure of thin safeguard film specified to various models of cellular phone.

Also, the present invention has another advantage that it can be utilized in general purpose without being subjected to a specific model of cellular phone by enhancing adhesion force corresponding to various adhering portions of the cellular phone.

### BRIEF DESCRIPTION OF THE DRAWINGS

FIG. 1 is a perspective view illustrating a safeguard film for a cellular phone according to the present invention is attached to a surface of the cellular phone.

FIG. 2 is a partial magnified view illustrating various structures of the adhesion facilitating means provided on the safeguard film for the cellular phone according to the present invention.

FIG. 3 is a front view illustrating specific structure of the safeguard film provided with the adhesion facilitating means according to the present invention.

FIG. 4 is a front view illustrating another specific structure of the safeguard film provided with the adhesion facilitating means according to the present invention.

FIG. 5 a front view illustrating another specific structure of the safeguard film provided with the adhesion facilitating means according to the present invention.

FIG. 6 is a partial magnified view of a split protection part additionally provided on the safeguard film according to the present invention.

### BEST MODE FOR CARRYING OUT THE INVENTION

A structure of safeguard film for cellular phone, comprising: at least one of adhesion facilitating means 20, 30, 40, 50, and 60 comprising: inception parts 21, 31, 41, 51, and 61 where a side wall 11 of a safeguard film 10 begins to depress with a certain length toward inside of the safeguard film; inside extension parts 22, 32, 42, 52, and 62 extending from the inception parts 21, 31, 41, 51, and 61 toward the inside of the safeguard film 10 in a manner that width of the inside is narrower than that of the outside; and tips 23, 33, 43, 53, and 63 formed with a curvature on end of the inside extension parts 22, 32, 42, 52, and 62.

### MODE FOR THE INVENTION

In order to achieve purpose described above, a structure of a safeguard film for a cellular phone according to the present invention is characterized by comprising an adhesion facilitating means comprising: inception parts 21, 31, 41, 51, and 61 where a side wall 11 of a safeguard film 10 begins to form a depression with a certain length toward inside of the safeguard film; inside extension parts 22, 32, 42, 52, and 62 extending from the inception parts 21, 31, 41, 51, and 61 toward the inside of the safeguard film 10 in a manner that the inside is narrower than the outside; and tips 23, 33, 43, 53, and 63 formed with curvature on the end of the inside extension parts 22, 32, 42, 52, and 62.

Also, the present invention is characterized in that the inception part 41 forms the depression inwardly with an angle of 30 to 45 degree on an edge of the safeguard film 10, that the inside extension part 42 further comprises: an extension side wall 42A having an inclination on a side thereof and being streamlined to be connected to the inception part 41; and a bending part 42B extending from an end to the other end and being bent with a certain angle, and that the tip 43 is formed with curvature on the end of the bending part 42B.

In addition, the present invention is characterized in that a split protection part 70 is further provided along an exterior surface of the tips 23, 33, 43, 53, and 63.

Hereinafter, preferred embodiments of the present invention will be described in detail in reference with the attached drawings. The attached drawings are not illustrated according to exact scale. Same components of the invention are referred by same numerals throughout the drawings.

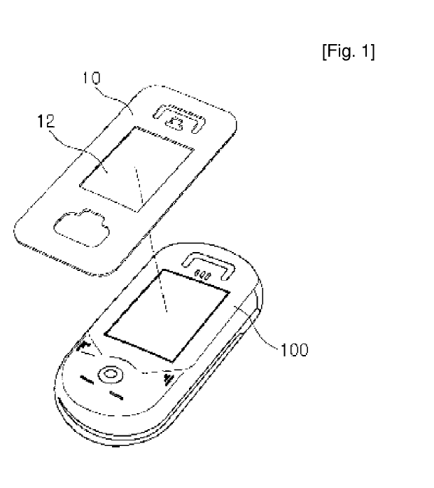

FIG. 1 is a perspective view illustrating the safeguard film 10 for the cellular phone according to the present invention is attached to a surface of the cellular phone 100.

As shown in FIG. 1, the safeguard film 10 according to the present invention may be attached to specific parts such as display part, key pad part, battery part, or a whole surface of the cellular phone, or a whole surface on the top of the cellular phone 100 except for the display part. Particularly, FIG. 1 illustrates the safeguard film 10 is attached on the whole surface of the cellular phone 100.

Although the film 10 according to the present invention is not affected by whether an attaching part of the cellular phone 100 is flat or curved, the safeguard film 10 according to the present invention may preferably exercise its functionality better when at least a portion of the cellular phone is curved.

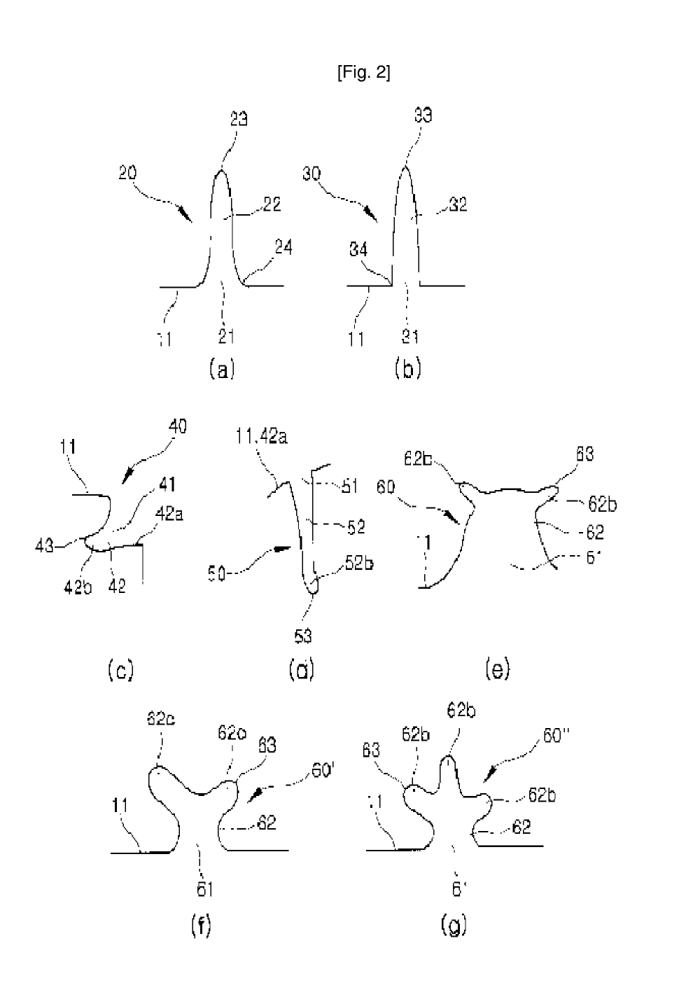

FIG. 2 is a magnified view illustrating various structures of the adhesion facilitating means 20, 30, 40, and 50 provided on the safeguard film 10 for the cellular phone according to the present invention.

First, the adhesion facilitating means 20, 30, 40, 50, and 60 is shaped as a groove or a cleavage that is depressed with a certain length and a certain width toward the inside of the safeguard film 10, and comprises the inception parts 21, 31, 41, 51, and 61, the inside extension parts 22, 32, 42, 52, and 62, and the tips 23, 33, 43, 53, an 63.

The inception parts 21, 31, 41, 51, and 61 refer to a portion where a side wall 11 of the safeguard film 10 or a portion of the exterior surface of the safeguard film 10 begins to depress toward the inside of the safeguard film 10 with a certain width. Herein, width of the inception parts 21, 31, 41, 51, and 61 is configured to be broader than the width of the inside extension parts 22, 32, 42, 52, and 62, as described later. Also, an angle from a side of the safeguard film 10 with which the inception parts 21, 31, 41, 51, and 61 depress toward the inside of the safeguard film 10 is not limited to a certain range of angle. However, it is generally an angle approximating a perpendicular angle to the side wall 11 of the safeguard film 10. Herein, various structures of the inception parts 21, 31, 41, 51, and 61 may be implemented based on the angle that the depression takes.

The inside extension parts 22, 32, 42, 52, and 62 refer to a portion formed from the inception parts 21, 31, 41, 51, and 61 and extending with a certain length toward the inside of the safeguard film 10. Herein, its width becomes narrower as it extends to the end or the tips 23, 33, 43, 53, and 63. However, it is preferable that the depression takes a shape of streamline or a shape of an arc of an ellipse having a certain curvature rather than a linear shape in which its inside is narrower than its outside. As the width of the inside extension parts 22, 32, 42, 52, and 62 is narrower than that of the inception parts 21, 31, 41, 51, and 61, overall shape that the inception parts 21, 31, 41, 51, and 61 and the inside extension parts 22, 32, 42, 52, and 62 form together takes a shape similar to a curve of normal distribution used in statistics.

The tips 23, 33, 43, 53, and 63 refer to ends of the inside extension parts 22, 32, 42, 52, and 62. Herein, its shape is formed with a curvature, so that the tip takes a smoothed shape or filleted shape rather than a sharp shape. The reason for taking such shape is to prevent the tips 23, 33, 43, 53, and 63 from being torn easily by a certain outer impact.

The adhesion facilitating means 20, 30, 40, and 50 having such structure and shape function to facilitate adhesion force between an adhering portion of the safeguard film 10 and the cellular phone 100.

In other words, as an example, in case that the adhering portion of the cellular phone 100 takes a shape of a mathematical curve resulted from the quadratic function having a point of inflection or a maximum or minimum value when seen from its side, the safeguard film 10 having a flat shape will not get stuck on the adhering portion of the cellular phone 100 completely when it is covered on the cellular phone 100. Instead, a portion of the safeguard film 10 will certainly get loose. Besides, as the safeguard film 10 cannot stay on the cellular phone 100 for a long period of time, the safeguard film 10 may get distorted or wrinkled, which prevents the safeguard film 10 from performing its function fully. Accordingly, an area of the side wall 11 of the safeguard film 10 corresponding to the curved portion of the cellular phone 100 should be form with a certain cleavage. Herein, the structure should form the adhesion facilitating means 20, 30, 40, and 50 comprising the inception parts 21, 31, 41, 51, and 61, the inside extension parts 22, 32, 42, 52, and 62, and the tips 23, 33, 43, 53, and 63, so that it can create an adhering surface of the safeguard film 10 which can facilitate adhering closely to the cellular phone 100 along the curved surface of the cellular phone 100. As a result, it properly performs functions of preventing unnecessary gaps caused by loosened safeguard film 10 and of preventing the safeguard film 10 from being distorted or wrinkled on a certain portion.

A reason why the adhesion facilitating means 20, 30, 40, and 50 have to be shaped along a curve of normal distribution used in statistics as described above is that the safeguard film 10 can be moved more flexibly on a curved adhering portion of the cellular phone 100 rather than on a edged structure of the cellular phone 100 such as a square shape.

FIG. 2 shows various embodiments of the adhesion facilitating means 20, 30, 40, and 50 according to the present invention. Herein, FIG. 2A illustrates a first embodiment titled as “adhesion facilitating means 20 with a curved inception part” according to the present invention. This embodiment comprises a fillet 24 formed by curving a boundary portion between the inception part 21 and a side wall 11 of the safeguard film 10.

As a result, the fillet 24 formed by curving the boundary portion between the inception part 21 and the side wall 11 of the safeguard film 10 can reduce tension applied from outside to the boundary portion between the inception part 21 and the side wall 11 of the safeguard film 10. Accordingly, it can prevent the boundary portion between the inception part 21 and the side wall 11 of the safeguard film 10 from being torn easily.

FIG. 2B illustrates a second embodiment titled as “adhesion facilitating means 30 with a perpendicular inception part” according to the present invention. Herein, it is characterized in that it is formed with a perpendicular part 34 on the boundary portion between the inception part 21 and the side wall 11 of the safeguard film 10 instead of the fillet 24 formed on the adhesion facilitating means 20 with a curved inception part. If the adhering portion of the cellular phone 10 having numerous protrusions or components corresponds to the boundary portion between the inception part 31 and the side wall 11 of the safeguard film 10, the boundary portion should closely match with the shape of such protrusions. In such case, however, the safeguard film 10 using the smoothed fillet 24 may make a gap on the adhering portion or cannot cover the adhering portion of the cellular phone 100 appropriately. So, in order to prevent such deficiency, the second embodiment employs the perpendicular part 34 having a 90 degree-angled edge where the inception part 31 meets the inside extension part 32. In this way, this embodiment can be used for a particular type of cellular phone 100 formed with numerous protrusions on the adhering portion.

FIG. 2C illustrates the third embodiment according to the present invention. The third embodiment according to the present invention is titled as “adhesion facilitating means 40 for corners”. This embodiment may be applied to a corner of the safeguard film 10 in order to facilitate adhesion to an adhering portion of curved corners of the cellular phone 10. Herein, the inception part 41 is formed by removing an area of the safeguard film 10 approximately corresponding to a square having a certain length, and is connected directly to the inside extension part 42.

The inside extension part 42 extends directly from the inception part 41 and is streamlined roughly. It has a roughly-flat extension side wall 42A having a slight inclination. Also, it has a shape that a corner or an upper boundary portion with the inception part 41 of the safeguard film extends approximately 30 to 45 degree toward the inside. The inside extension part 42 comprises the bending part 42B bent and extending to a certain direction from an extended line of the inside extension part 42, that is, upwardly or downwardly, and the tip 43 formed on an end of the bending part 42B.

Herein, the reason why the inside extension part 42 should have a certain angle with the inception part 41 or the corner of the safeguard film 10 is as follows. The safeguard film 10 includes corners in its structure. Accordingly, safeguard film 10 may not be formed or formed weak on the top of the inside extension part 42 with a risk of being torn, in case that the inside extension part 42 extends in parallel with the corners or extends with a slight inclination, in order to give some flexibility in adhering between a portion of the safeguard film 10 positioned on top of the inside extension part 42 and the cellular phone 100. To solve such problem, the inside extension part should extend toward inside with some inclination and the top of the safeguard film 10 should cover the area properly while providing a certain flexibility to the corner of the safeguard film 10 contacting an adhering portion of the corner of the cellular phone 100. In addition, the bending part 42B is formed to provide an elastic flexibility when attaching the safeguard film to the corner of the cellular phone 100, because the inside extension part 42 would not have a proper protrusion on the part corresponding to the top of the safeguard film 10 if the inside extension part just extends toward the inside with the inclination described above. However, as the corresponding portion of the safeguard film 10 has a protrusion shape due to the bending part 42B, adhesion of an area of the safeguard film 10 against the cellular phone can be facilitated. An end of the bending part 42B is also formed with a curved tip for smoothing.

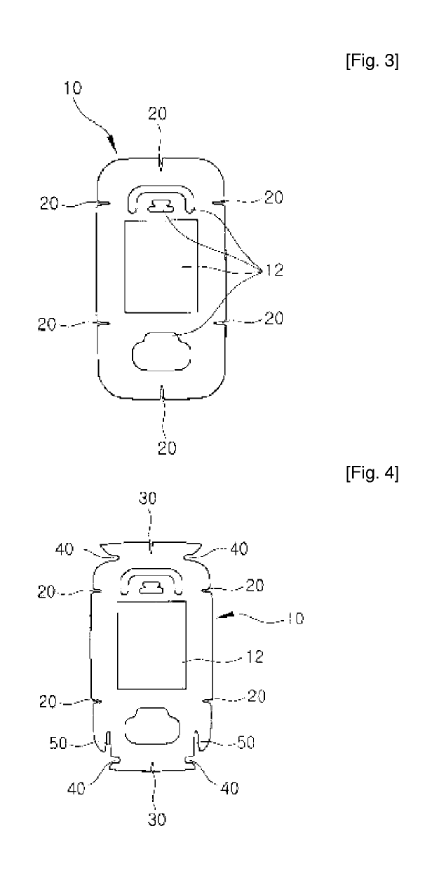

FIG. 2D illustrates a fourth embodiment according to the present invention. The fourth embodiment according to the present invention is titled as “adhesion facilitating means 50 for reinforcing”. This embodiment utilizes an additional cleavage so that it may be used for a surface of the cellular phone 100 having a curve of quadratic function, or a surface that requires an additional adhering force such as an edge of the cellular phone 100. Accordingly, the safeguard film 10 can be attached on the cellular phone 100 more flexibly. To ensure that, the inception part 51 of the adhesion facilitating means 50 for reinforcing may begin from one side wall of the safeguard film 10, however, it may preferably begin from the extension side wall 42A of the adhesion facilitating means 40 as shown in FIG. 3. Also, it is possible that it begins from the inception parts 21 and 31 of the other types of adhesion facilitating means 20 and 30 according to the necessity.

If the adhesion facilitating means 50 is formed beginning from the extension side wall 42A of the adhesion facilitating means 40, the safeguard film 10 is commonly likely to deviate from an edge part of the cellular phone 100. Accordingly, this embodiment is devised to reinforce the function of preventing such problem.

Meanwhile, it is meaningful that this embodiment provides a plurality of cleavages or grooves of the safeguard film 10 corresponding to the surface portion of the cellular phone 100 having a curve of the quadratic function which is troublesome in attaching a thin safeguard film 10 to an adhering area with protrusions.

The adhesion facilitating means 50 comprises the inception part 51, the inside extension part 52. Also, it may further comprise the bending part 52B. If it is the case, the bending part 52B is formed with the tip 53 on an end. Particularly, the inception part 51 is formed toward inside with a slight inclination, not being formed perpendicularly, from the side wall 11 or the extension side wall 42A of the safeguard film 10. This means that this embodiment may have the inception part 51 and the inside extension part 52 having an arbitrary inclination specified to a surface structure, based on the surface structure of the each cellular phone 100.

FIG. 2E illustrates a fifth embodiment according to the present invention. The fifth embodiment according to the present invention is titled as “additional adhesion facilitating means 60 for corners”. It may be utilized for adhering a corner of the cellular phone in the same manner as the third embodiment.

Specifically, the inception part 61 is formed from the side wall 11 of the safeguard film toward the inside of the film 10. Herein, width of the inception part 60 is set to be broader than that of other types of inception parts. The inside extension part 62 is formed form the inception part and extends toward the inside of the film 10 while getting narrower. The inside extension part 62 comprises two split inside extension parts 62B branching off in both directions. In other words, an end of the inside extension part 62 is split into both directions, further forming deeper toward the inside of the film 10, which makes the split inside extension parts 62B.

The ends of the split inside extension parts 62B are formed with the tips 63 having curvature.

The additional adhesion facilitating means 60 for corners devised by the present inventor to compensate a disadvantage that the corners of the adhering part of the cellular phone are weak. Herein, the split inside extension parts 62B formed by further extending the inside extension part 62 toward the inside in both directions make two additional protrusions around the corners of the film 10, so that adhering force against the cellular phone may be reinforced using such two protrusion parts.

FIG. 2F illustrates a sixth embodiment according to the present invention. The sixth embodiment according to the present invention is titled as “modified additional adhesion facilitating means 60′ for corners” which is a modified form of the “additional adhesion facilitating means 60 for corners” shown in FIG. 2E. Specifically, the modified additional adhesion facilitating means 60′ for corners has the similar structure and function with the additional adhesion facilitating means 60 for corners. However, this embodiment comprises: a long split inside extension part 62C which is formed by elongating one of two split inside extension parts 62B shown in FIG. 2E; and a short split inside extension part 62D which is formed to be relatively shorter than the long split inside extension part 62C. The reason in providing those split inside extension parts 62C and 62D of two different lengths is to differentiate contacts of the long split inside extension part 62C and short split inside extension part 62D so that close adhesion on the cellular phone with various protrusions can be enhanced.

FIG. 2G illustrates a seventh embodiment according to the present invention which is a modified form of the fifth embodiment. Specifically, the seventh embodiment realizes three split inside extension parts 62B, so that it can provide the most excellent adhesion in case of attaching the film 10 on a rounded portion of the cellular phone. This embodiment may have more increased adhesion force on the corners than the fifth embodiment, because of increased number of protrusions made by the three split inside extension parts 62B.

FIG. 3 is a front view of the safeguard film 10 for cellular phone according to the present invention.

As shown in FIG. 3, the safeguard film 10 comprises a plurality of openings 12 on a central area thereof. The openings 12 are optional components which may be consider to be irrelevant to the core idea of the present invention. However, if the openings 12 are provided, it is for the purpose to allow additional safeguard film to be attached to a flat portion of the cellular phone 100 such as display part.

FIG. 3 illustrates an example of the adhesion facilitating means 20 having curved inception part being formed on the side wall 11 of the safeguard film 10, to which the present invention may not be limited. Meanwhile, it is also possible to provide a plurality of adhesion facilitating means 20, 30, 40, 50, and 60 according to each position of the side wall 11 of the safeguard film or a required interval.

FIG. 4 is a front view illustrating another example of safeguard film 10 for cellular phone according to the present invention.

As shown in FIG. 4, various adhesion facilitating means 20, 30, 40, and 50 according to the present invention may be provided symmetrically or asymmetrically in plurality according to position of each side wall 11 in one safeguard film 10. Particularly, as understood from FIG. 4 depicting that the adhesion facilitating means 50 for reinforcing is additionally formed on the adhesion facilitating means 40 for corners, it is preferable that the adhesion facilitating means 50 for reinforcing is utilized for reinforcing other types of adhesion facilitating means 20, 30, and 40.

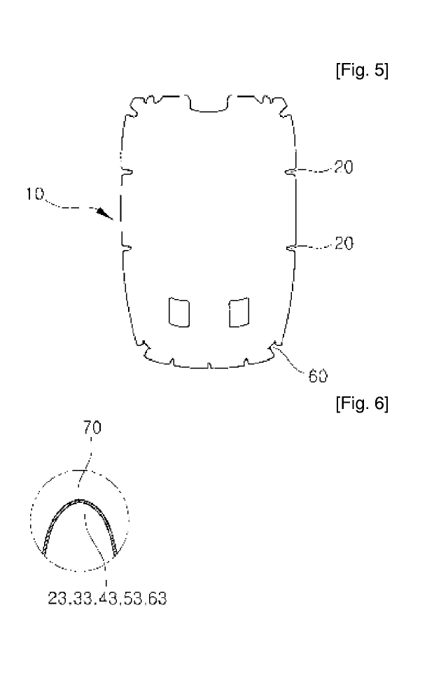

FIG. 5 illustrates an exemplary state that the safeguard film 10 formed with the additional adhesion facilitating means 60 for corners is attached on the cellular phone.

As shown in FIG. 5, a corner of the film 10 is formed with the adhesion facilitating means 60 according to the fifth embodiment of the present invention, which ensures better adhesion between the film 10 according to the present invention and the cellular phone.

FIG. 6 is a partial magnified front view of the split protection part 70 additionally provided on the adhesion facilitating means 20, 30, 40, 50, and 60 according to the present invention.

Because the adhesion facilitating means 20, 30, 40, 50, and 60 can be considered to be a cleavage or a groove depressing from the side wall 11 of the safeguard film 10 in consideration of its appearance, there still exists a risk that the tips 23, 33, 43, 53, and 63 can be torn off by the pressure concentrated on the cleavage of narrow width. Accordingly to prevent such problem, the tips 23, 33, 43, 53, and 63 are additionally formed with the split protection part 70 being thicker than other part and being made of synthetic resin having higher durability along the outer peripheries of the tips 23, 33, 43, 53, and 63.

As a result, the adhesion facilitating means 20, 30, 40, 50, and 60 overcomes such disadvantage that the inside of the safeguard film 10 is easily torn off by a slight impact from outside, so that the safeguard film 10 can be utilized being properly attached on the cellular phone 100 for a long period of time.

As described above, the structure and its function of the safeguard film for cellular phone according to the present invention have been explained. However, these are only exemplary embodiments and drawings thereof to which the idea of the present invention is not limited. Accordingly, it is also possible to modify or change the embodiments within the scope of the invention without departing from the idea of the invention.

1. A structure of safeguard film for cellular phone, comprising:
at least one of adhesion facilitating means 20, 30, 40, 50, and 60 comprising:
inception parts 21, 31, 41, 51, and 61 where a side wall 11 of a safeguard film 10 begins to depress with a certain length toward inside of the safeguard film;
inside extension parts 22, 32, 42, 52, and 62 extending from the inception parts 21, 31, 41, 51, and 61 toward the inside of the safeguard film 10 in a manner that width of the inside is narrower than that of the outside; and
tips 23, 33, 43, 53, and 63 formed with a curvature on end of the inside extension parts 22, 32, 42, 52, and 62.

2. The structure of safeguard film for cellular phone according to claim 1, further comprising a fillet 24 formed by curving a boundary portion between the inception part 21 and the side wall 11 of the safeguard film.

3. The structure of safeguard film for cellular phone according to claim 1, which is characterized in that
the inception part 41 forms the depression inwardly with an angle of 30 to 45 degree on an edge of the safeguard film 10,
that the inside extension part 42 further comprises: an extension side wall 42A having an inclination on a side thereof and being streamlined to be connected to the inception part 41; and a bending part 42B extending and being bent with a certain angle, and
that the tip 43 is formed with curvature on the end of the bending part 42B.

4. The structure of safeguard film for cellular phone according to claim 1 or claim 3, which is characterized in that
the inception part 51 is depressed toward the inside with a certain angle from the side wall 11 or the extension side wall 42A of the safeguard film 10.

5. The structure of safeguard film for cellular phone according to claim 1, which is characterized in that
the inside extension part 62 comprises two split inside extension parts 62B branching off in both directions toward the inside of the safeguard film 10.

6. The structure of safeguard film for cellular phone according to claim 5, which is characterized in that
the split inside extension part 62B is provided as a long split inside extension part 62C and a short split inside extension part 62D which is formed to be relatively shorter than the long split inside extension part 62C.

7. The structure of safeguard film for cellular phone according to claim 1, which is characterized in that
the inside extension part 62 comprises three split inside extension parts 62B branching off in three directions toward the inside of the safeguard film 10.

8. The structure of safeguard film for cellular phone according to claim 1, further comprising a split protection part 70 formed along peripheries of the tips 23, 33, 43, 53, and 63.
